(19) United States
(12) Patent Application Publication
(10) Pub. No.: US 2026/0302190 A1
(43) Pub. Date: Oct. 1, 2026

(54) CATHODE ACTIVE MATERIAL FOR LITHIUM SECONDARY BATTERY, METHOD FOR PREPARING THE SAME, AND LITHIUM SECONDARY BATTERY INCLUDING THE SAME

(71) Applicant: UIF (University Industry Foundation), Yonsei University, Seoul (KR)

(72) Inventors: Yoon Seok JUNG, Seoul (KR); Jun Pyo SON, Seoul (KR)

(73) Assignee: UIF (University Industry Foundation), Yonsei University, Seoul (KR)

(21) Appl. No.: 19/570,485

(22) Filed: Mar. 18, 2026

(30) Foreign Application Priority Data
Mar. 26, 2025 (KR) 10-2025-0038813
Feb. 20, 2026 (KR) 10-2026-0031575

(51) Int. Cl. H01M 4/36; H01M 4/02; H01M 4/04; H01M 4/1315; H01M 4/505; H01M 4/525; H01M 10/0562

(52) U.S. Cl. CPC H01M 4/366; H01M 4/0428; H01M 4/1315; H01M 4/505; H01M 4/525; H01M 10/0562; H01M 2004/021; H01M 2004/028; H01M 2220/20; H01M 2220/30; H01M 2300/008

(57) ABSTRACT

The present invention relates to a cathode active material for a lithium secondary battery having excellent performance, a method for preparing the same, and a lithium secondary battery including the same, and by forming a lithium-metal-oxygen (Li-M-O) layer by atomic layer deposition (ALD) and then forming a lithium-metal-oxygen-fluorine (Li-M-O—F) protection layer through vapor phase fluorination treatment, it is possible to uniformly coat not only the surface of the cathode active material but also the grain boundaries inside the active material, thereby improving high voltage stability and long-term lifespan characteristics of an all-solid-state battery.

### CROSS-REFERENCE TO RELATED APPLICATIONS

This application claims priority to Korean Patent Application Nos. 10-2025-0038813 and 10-2026-0031575, filed on Mar. 26, 2025 and Feb. 20, 2026, respectively and all the benefits accruing therefrom under 35 U.S.C. § 119, the contents of which in its entirety are herein incorporated by reference.

### BACKGROUND

### 1. Field

The present invention relates to a cathode active material for a lithium secondary battery, a method for preparing the same, and a lithium secondary battery including the same.

### 2. Description of Related Art

All-Solid-State Battery (ASSB) is attracting attention as a next-generation secondary battery technology capable of improving safety and energy density by replacing a liquid electrolyte with a Solid Electrolyte (SE).

However, in the case of an all-solid-state battery system driven at a high voltage (4.5 V or higher), the high voltage reaction at the cathode/solid electrolyte interface determines performance and lifespan. Some inorganic solid electrolytes may decompose at high voltages to accompany the generation of volatile by-products as well as solid by-products, and these by-products may penetrate along the cathode microstructure path to form side reaction products at grain boundaries, which may inhibit Li+ transport and interfacial charge transfer.

The high voltage driving of an all-solid-state battery easily induces a decomposition reaction of the electrolyte at the solid electrolyte/cathode interface, whereby resistive by-products accumulate, and polarization and impedance growth may increase.

Oxide-based protection layers (e.g., LiNbO₃, etc.) have a possibility of converting into resistive by-products due to composition change or decomposition under high voltage conditions, which may lead to degradation of the cell including an increase in interfacial resistance in long-term driving.

A surface-centered protection layer does not sufficiently control the reaction proceeding inside the cathode microstructure (region adjacent to grain boundaries) or the accumulation of by-products, so that degradation of the battery such as deterioration of Li+ transport and interfacial charge transfer may be increased.

In addition, ion conduction of the interfacial protection layer also plays an important role in an all-solid-state battery system, and when only fluorination is proceeded to increase high voltage stability without a lithium-aluminum oxide (Li—Al—O) layer, smooth lithium ion movement at the interface between the cathode and the solid electrolyte is hindered, so that resistance in the battery may rather increase.

### REFERENCES

U.S. Pat. No. 11,342,176
U.S. Pat. No. 9,692,041
US Patent Publication No. 2022/0344642
US Patent Publication No. 2017/0229742

### SUMMARY

The present invention intends to solve the technical problems possessed by the existing technologies examined above, provide a cathode active material for a lithium secondary battery having excellent performance, a method for preparing the same, and a lithium secondary battery including the same, and ultimately improve high voltage stability and long-term lifespan characteristics of an all-solid-state battery through this.

One aspect of the present invention relates to a cathode active material for a lithium secondary battery comprising: (A) a cathode active material core including a lithium transition metal oxide, and (B) a lithium-metal-oxygen-fluorine (Li-M-O—F) protection layer formed on at least a part of the surface of said cathode active material core.

Another aspect of the present invention relates to a method for preparing a cathode active material for a lithium secondary battery comprising:
(S1) forming a lithium-metal-oxygen (Li-M-O) layer on a cathode active material core including a lithium transition metal oxide, and
(S2) performing a vapor phase fluorination treatment on said lithium-metal-oxygen (Li-M-O) layer to form a lithium-metal-oxygen-fluorine (Li-M-O—F) protection layer.

Another aspect of the present invention relates to a cathode including the cathode active material according to various embodiments of the present invention.

Another aspect of the present invention relates to a lithium secondary battery including the cathode according to various embodiments of the present invention.

Another aspect of the present invention relates to an all-solid-state battery including the cathode according to various embodiments of the present invention, and a solid electrolyte.

According to various embodiments of the present invention, the technical problems possessed by the existing technologies examined above are solved, and a cathode active material for a lithium secondary battery having excellent performance, a method for preparing the same, and a lithium secondary battery including the same are provided, and ultimately, through this, high voltage stability and long-term lifespan characteristics of an all-solid-state battery can be improved.

### BRIEF DESCRIPTION OF THE DRAWINGS

FIG. 1 shows a schematic diagram of a process of introducing a Li—Al—O—F interface protection layer.

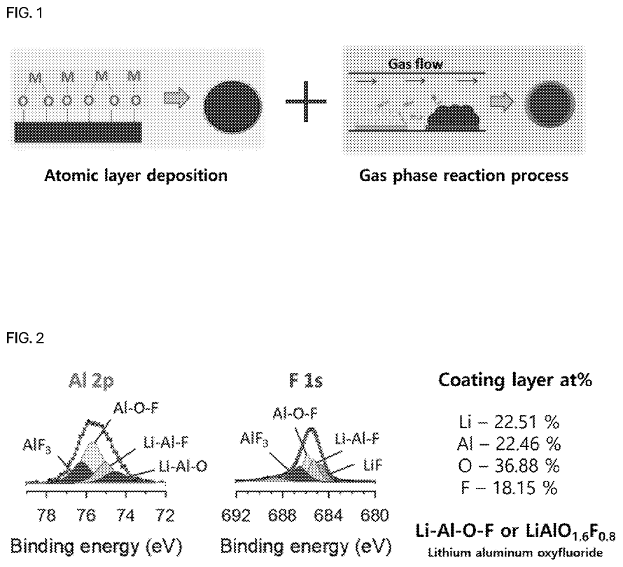

FIG. 2 shows X-ray Photoelectron Spectroscopy (XPS) analysis results of the interface protection layer.

FIG. 3 shows Scanning Electron Microscope (SEM) images of a cathode into which an interface protection layer is introduced and Energy Dispersive X-ray Spectroscopy (EDS) element mapping results according thereto.

FIG. 4A shows Transmission Electron Microscope (TEM) images of a cathode into which an interface protection layer is introduced and EDS element mapping results according thereto. FIG. 4B shows TEM images of a cathode into which an interface protection layer is introduced and line EDS element mapping results according thereto.

FIG. 5 shows electrochemical evaluation (rate capability) results of Example 1 and Comparative Example 1 proceeded at a high driving pressure of 70 MPa.

FIG. 6 shows electrochemical evaluation (rate capability) results of Example 2 and Comparative Examples 2 and 4 proceeded at a high driving pressure of 70 MPa.

FIG. 7 shows electrochemical evaluation (rate capability) results of Example 2 and Comparative Examples 2 and 5 proceeded at a high driving pressure of 70 MPa.

FIG. 8 shows electrochemical evaluation (lifespan characteristics) comparison results of Example 2 and Comparative Example 2 proceeded at a high driving pressure of 70 MPa.

FIG. 9 shows electrochemical evaluation (rate capability) comparison results of Example 1 and Comparative Example 1 (left, sulfide-based electrolyte) and Example 3 and Comparative Example 3 (right, halide-based electrolyte) proceeded at a low driving pressure of 3 MPa.

FIG. 10 shows electrochemical evaluation (lifespan characteristics) comparison results of Example 3 and Comparative Example 3 proceeded at a low driving pressure of 3 MPa.

FIG. 11 shows electrochemical evaluation results (including initial coulombic efficiency) of Examples and Comparative Examples using a sulfide-based solid electrolyte.

FIG. 12 shows electrochemical evaluation results (including initial coulombic efficiency) of Examples and Comparative Examples using a halide-based solid electrolyte.

FIG. 13 shows electrochemical evaluation (charge/discharge profile) results of Example 4 and Comparative Example 6 proceeded at a high driving pressure of 70 MPa.

FIG. 14 shows electrochemical evaluation (lifespan characteristics) comparison results of Example 5 and Comparative Example 7 proceeded at a low driving pressure of 3 MPa.

### DETAILED DESCRIPTION

Hereinafter, several aspects and various embodiments of the present invention will be examined in more detail.

In the present specification, expressions such as ‘include’, ‘have’, ‘consist of’, ‘composed of’, etc. allow other parts to be added unless ‘~only’ is used. In addition, when a component is expressed in the singular in the present specification, it also includes the case of a plurality of components unless specifically explicitly stated otherwise. In addition, numerical values or numerical ranges described in the present specification are interpreted to include an error range even if there is no separate explicit description. In addition, the expression ‘X to Y’ representing a numerical range in the present specification means ‘X or more and Y or less’.

Hereinafter, examples of the present invention will be described in detail with reference to the drawings. However, detailed descriptions of known functions or configurations that may obscure the gist of the present invention in the following description and accompanying drawings will be omitted.

Unless specifically defined otherwise, all terms used herein including technical or scientific terms have the same meaning as generally understood by those of ordinary skill in the art to which the present invention belongs. Terms such as those defined in generally used dictionaries should be interpreted as having a meaning consistent with the meaning in the context of the relevant technology, and are not interpreted in an ideal or excessively formal sense unless explicitly defined in the present application.

One aspect of the present invention relates to a cathode active material for a lithium secondary battery comprising:
(A) a cathode active material core including a lithium transition metal oxide, and
(B) a lithium-metal-oxygen-fluorine (Li-M-O—F) protection layer formed on at least a part of the surface of said cathode active material core.

The above lithium-metal-oxygen-fluorine (Li-M-O—F) protection layer is formed not only on the surface of the cathode active material but also at the grain boundaries inside the cathode active material according to several aspects and various embodiments of the present invention, thereby suppressing solid electrolyte decomposition and interfacial side reactions under high voltage conditions, and alleviating impedance growth and polarization increase.

If some of the components constituting the above protection layer are omitted, or if it is outside the above composition range, it is not preferable in that the effects according to several aspects and various embodiments of the present invention cannot be sufficiently exhibited.

In particular, an oxide-based protection layer alone that does not contain fluorine has a possibility of converting into resistive by-products due to composition change or decomposition under high voltage conditions, so the high voltage stability improvement effect of the oxyfluoride-based protection layer according to the present invention cannot be exhibited.

In several aspects of the present invention, according to one embodiment, the lithium transition metal oxide may be represented by the following Formula 1a.

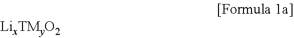

In Formula 1a, x is a real number of 0.5-1.5, preferably 0.8-1.2, more preferably 1.0-1.1, y is a real number of 0.5-1.5, preferably 0.8-1.2, more preferably 0.9-1.0, and TM is selected from Ni, Co, Mn, Al, Fe, Cr, V, Ti, Nb, Zr, W, Mo, Mg, Ca, Na, B, Si, P, and combinations thereof, preferably selected from Ni, Co, Mn, and combinations thereof, and more preferably selected from a combination of Ni, Co, and Mn.

In the case of the above preferred range or component, it is preferable in that structural stability is further improved during the insertion/extraction process of lithium ions, thereby improving the reversible capacity and cycle characteristics of the battery, and in the case of the above more preferable range or component, it is more preferable in that it is close to the composition of the Li-rich cathode material (Li_{1.08}Ni_{0.37}Co_{0.02}Mn_{0.53}O₂) as confirmed in the examples, so that high voltage stability and high energy density can be achieved simultaneously.

According to another embodiment, the lithium transition metal oxide may be selected from a nickel-rich (Ni-rich) cathode material or a lithium-rich (Li-rich) cathode material.

According to another embodiment, the lithium transition metal oxide may be a cathode material of a spinel structure represented by the following Formula 1b.

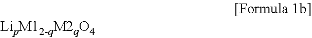

In Formula 1b, p is a real number of 0-2, preferably 0.5-1.5, more preferably 0.9-1.1, q is a real number of 0-2, preferably 0.5-1.5, more preferably 1.4-1.6, and M1 and M2 are each independently selected from Ni, Co, Mn, Al, Fe, Cr, V, Ti, Nb, Zr, W, Mo, Mg, Ca, Na, and combinations thereof, preferably selected from Ni, Co, Mn, and combinations thereof, and more preferably selected from a combination wherein M1 is Ni and M2 is Mn or a combination wherein M1 is Co and M2 is Mn.

In the case of the above preferred range or component, it is preferable in that the crystallinity of the spinel structure is improved so that the lithium ion diffusion path is further optimized, and in the case of the above more preferable range or component, it corresponds to a LiNi_{0.5}Mn_{1.5}O₄ (p=1, q=1.5, M1=Ni, M2=Mn) or LiCoMnO₄ (p=1, q=1, M1=Co, M2=Mn) composition, enabling stable driving even at a high voltage of 4.7 V or higher, and it is more preferable in that high voltage interfacial side reactions can be effectively suppressed when combined with the Li-M-O—F protection layer according to the present invention.

As a specific example, the cathode material of the spinel structure may be selected from LiNi_{0.5}Mn_{1.5}O₄, LiCoMnO₄, and combinations thereof.

In several aspects of the present invention, according to one embodiment, the lithium-metal-oxygen-fluorine (Li-M-O—F) protection layer may be represented by the following Formula 2.

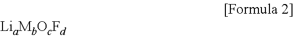

In Formula 2, a is a real number of 0-4, preferably 0.5-2, more preferably 0.8-1.2, b is a real number greater than 0 and 1 or less, preferably 0.5-1, more preferably 0.8-1.0, c is a real number of 0-4, preferably 1-2.5, more preferably 1.4-1.8, d is a real number greater than 0 and 4 or less, preferably 0.2-2, more preferably 0.6-1.0, and M is selected from Al, B, C, Nb, Ta, P, Si, and combinations thereof, preferably selected from Al, B, Nb, Ta, and more preferably Al.

In the case of the above preferred range or component, it is preferable in that lithium ion conductivity and high voltage stability are secured in a balanced manner by appropriate mixing of oxygen and fluorine in the oxyfluoride composition, and in the case of the above more preferable range or component, it corresponds to the LiAlO_{1.6}F_{0.8} composition (approximately a=1, approximately b=1, approximately c=1.6, approximately d=0.8 by normalizing Li 22.51%, Al 22.46%, O 36.88%, F 18.15%) confirmed by XPS quantitative results, so that an optimal balance between interfacial protection effect and ion conductivity can be achieved, and even if partial decomposition occurs, reconstruction into a LiF-based stable interface is possible, which is more preferable in that it is advantageous for securing long-term driving stability.

Meanwhile, the elements selectable as M in Formula 2, particularly the above preferred elements, are selected based on the common technical characteristic that they can form a complex oxide layer with lithium by atomic layer deposition (ALD), and the formed oxide layer can be converted into an oxyfluoride composition by vapor phase fluorination treatment.

Specifically, for Al, trimethylaluminum (TMA) is widely used as an ALD precursor; for B, trimethylboron (TMB) or triethylboron (TEB) or triisopropyl borate ([(CH₃)₂CHO]₃B, TIB); for Nb, niobium ethoxide (Nb(OEt)₅) or (tert-butylimido)tris(diethylamido)niobium (TBTDEN); for Ta, tantalum ethoxide (Ta(OEt)₅) or (tert-butylimido)tris(diethylamido)tantalum (TBTDET); for P, trimethyl phosphate (TMPO); for Si, tetraethylorthosilicate (TEOS) or silicon tetrachloride (SiCl₄) are commercially available as ALD precursors, respectively; and ALD processes using them are established in the technical field.

These elements can form stable lithium complex oxides such as LiAlO₂, Li₃BO₃, LiNbO₃, LiTaO₃, Li₃PO₄, Li₂SiO₃, etc. together with lithium, respectively, and such an oxide layer can be converted into an oxyfluoride composition by substituting a part of oxygen sites with fluorine by vapor phase fluorination treatment using a fluorine source such as XeF₂. In particular, LiNbO₃ is a material already being utilized as an interface protection layer for all-solid-state battery cathode materials, and Li₃PO₄ is known to have excellent lithium ion conductivity as a basic composition of LIPON-based solid electrolytes, so it is expected that an oxyfluoride protection layer formed therefrom can also exhibit a similar interface protection effect.

However, the Al is most preferable in that film formation uniformity and reproducibility in the ALD process are most excellent, and the formed Li—Al—O—F composition can achieve an optimal balance of interface protection effect and ion conductivity as confirmed in the examples.

According to another preferred embodiment, the M is Al, and the protection layer has a Li—Al—O—F composition. Such a composition is advantageous in terms of high voltage stability, and even if partial decomposition occurs, reconstruction into a LiF-based stable interface is possible, which is advantageous for securing long-term driving stability.

According to one embodiment, the average chemical composition of the Li—Al—O—F protection layer may be LiAlO_{1.6}F_{0.8}. This is a composition confirmed based on X-ray Photoelectron Spectroscopy (XPS) quantitative results.

According to another embodiment, the thickness of the lithium-metal-oxygen-fluorine (Li-M-O—F) protection layer may be 1-20 nm. If it is less than the above range, the interface protection effect may not be sufficient, and if it exceeds the above range, it is not preferable because it may hinder lithium ion conduction and rather degrade battery performance.

According to a more preferred embodiment, the thickness of the protection layer is 2-10 nm, and particularly preferably 3-5 nm. When a uniform interface protection layer of about 4 nm thickness is formed, an optimal balance between interface protection effect and ion conductivity can be achieved.

According to another embodiment, the lithium-metal-oxygen-fluorine (Li-M-O—F) protection layer is formed not only on the surface of the cathode active material core but also at the grain boundaries inside the cathode active material core.

According to such an embodiment, the protection layer may be formed even at grain boundaries up to a depth of about 1 μm from the surface of the cathode active material. This is due to the characteristics of the diffusion/infiltration type coating provided by the vapor phase reaction-based process.

When the protection layer is formed not only on the surface of the cathode active material but also at the internal grain boundaries, side reactions and byproduct accumulation proceeding inside the cathode microstructure can be effectively controlled, which is advantageous in improving Li+ transport and interfacial charge transfer characteristics.

Another aspect of the present invention relates to a method for preparing a cathode active material for a lithium secondary battery comprising:
(S1) forming a lithium-metal-oxygen (Li-M-O) layer on a cathode active material core including a lithium transition metal oxide, and
(S2) performing a vapor phase fluorination treatment on said lithium-metal-oxygen (Li-M-O) layer to form a lithium-metal-oxygen-fluorine (Li-M-O—F) protection layer.

According to one embodiment, the lithium-metal-oxygen (Li-M-O) layer is a lithium-aluminum oxide (Li—Al—O, LAO) layer.

According to another embodiment, step (S1) may be performed using Atomic Layer Deposition (ALD) or a wet chemical method, etc., but is not limited thereto. In step (S1), the atomic layer deposition method is performed using a lithium precursor and a metal precursor.

As a specific example, the lithium precursor may be lithium tert-butoxide (LiOtBu), and the metal precursor may be trimethylaluminum (TMA).

According to another embodiment, in the atomic layer deposition method, the pulse time of the lithium precursor is 1.0-10.0 seconds, the exposure time is 0.1-2.0 seconds, and the purge time is 5-60 seconds. Preferably, the pulse time of the lithium precursor is 4.0 seconds, the exposure time is 0.5 seconds, and the purge time is 20 seconds.

According to another embodiment, in the atomic layer deposition method, the pulse time of the metal precursor is 0.1-1.0 seconds, the exposure time is 0.5-5.0 seconds, and the purge time is 5-60 seconds. Preferably, the pulse time of the metal precursor is 0.25 seconds, the exposure time is 2.0 seconds, and the purge time is 20 seconds.

According to another embodiment, in the atomic layer deposition method, the substrate temperature is 100-400° C., preferably 150-250° C., more preferably 200° C.

According to another embodiment, the atomic layer deposition method is performed using ozone (O₃) as an oxidant. The ozone may be generated from ultra high purity oxygen (O₂) using a UV ozone generator.

According to another embodiment, step (S1) may be performed by a wet chemical method instead of the atomic layer deposition method.

The wet chemical method may include forming a Li—Al—O layer from a homogeneous aqueous solution including lithium ethoxide and aluminum isopropoxide.

According to another embodiment, in the wet chemical method, the solvent is evaporated under vacuum at 60-100° C. using a rotary evaporator, and then heat-treated at 350-550° C. for 0.5-3 hours in an air atmosphere.

However, when the same fluorination treatment is performed after forming the Li—Al—O layer by the wet chemical method, performance may be lower compared to the case where the Li—Al—O layer is formed by the atomic layer deposition method. This suggests that the atomic layer deposition method should be preceded for uniform and dense precursor layer formation.

According to another embodiment, the vapor phase fluorination treatment in step (S2) is performed using a fluorine source.

The fluorine source may be selected from XeF₂, NH₄F, SF₆, CF₄, TiF₄, TaF₅, and combinations thereof. Preferably, the fluorine source is XeF₂.

According to another embodiment, the vapor phase fluorination treatment is performed by placing the cathode active material on which the Li-M-O layer is formed and the fluorine source in separated containers and then heating inside a sealed reactor.

According to another embodiment, the mass ratio of the cathode active material and the fluorine source is 5:1 to 20:1, preferably 10:1.

According to another embodiment, the vapor phase fluorination treatment temperature is 30-100° C., preferably 50-70° C., more preferably 60° C.

According to another embodiment, the vapor phase fluorination treatment time is 1-24 hours, preferably 4-10 hours, more preferably 6 hours.

When the vapor phase fluorination treatment is performed under these conditions, the Li—Al—O precursor layer formed by ALD is partially fluorinated and converted into an oxyfluoride composition (Li—Al—O—F).

According to a preferred embodiment, it is not preferable to perform only the vapor phase fluorination treatment of step (S2) alone without the Li—Al—O layer in step (S1). In the case where only fluorination is treated alone, it is difficult to sufficiently form a Li+ conductive protection layer on the cathode surface, and polarization may rather increase, causing a decrease in capacity.

Another aspect of the present invention relates to a cathode including the cathode active material according to various embodiments of the present invention.

According to one embodiment, the cathode is a composite cathode including a cathode active material, a solid electrolyte, and a conductive material.

According to one embodiment, the weight ratio of the cathode active material, solid electrolyte, and conductive material is 60:30:5 to 80:40:10, preferably 70:50:5.

According to one embodiment, the conductive material includes vapor-grown carbon fibers.

Another aspect of the present invention relates to a lithium secondary battery including the cathode according to various embodiments of the present invention.

Another aspect of the present invention relates to an all-solid-state battery including the cathode according to various embodiments of the present invention, and a solid electrolyte.

According to one embodiment, the solid electrolyte is selected from a sulfide-based solid electrolyte and a halide-based solid electrolyte.

According to another embodiment, the sulfide-based solid electrolyte may be Li₆PS₅Cl (LPSCl).

According to another embodiment, the halide-based solid electrolyte may be selected from a Li₃YCl₆-based electrolyte, a ZrO₂ doped Li₂ZrCl₅F electrolyte, and combinations thereof.

The Li-M-O—F protection layer according to the present invention exhibits an excellent interface protection effect even when used with both sulfide-based and halide-based solid electrolytes.

According to another embodiment, the all-solid-state battery is configured to operate at a driving pressure of 70 MPa or less.

According to a more preferred embodiment, the all-solid-state battery exhibits excellent performance even under low pressure driving conditions of 1-10 MPa, preferably 3 MPa. The interface protection strategy according to the present invention is effective even in a low pressure environment, which has significant meaning from the perspective of commercialization of all-solid-state batteries.

According to another embodiment, the all-solid-state battery is configured to be driven at a high voltage of 4.5 V or higher. Preferably, the all-solid-state battery is driven in the range of 2.3-5.0 V (vs Li/Li⁺), and the voltage range may vary depending on the type of cathode material.

According to another embodiment, the all-solid-state battery has improved Initial Coulombic Efficiency (ICE) compared to an all-solid-state battery including a cathode active material that does not include a Li-M-O—F protection layer.

According to another embodiment, the all-solid-state battery has improved rate capability compared to an all-solid-state battery including a cathode active material that does not include a Li-M-O—F protection layer. This is attributed to the improvement in reversible capacity due to the interface protection effect of the Li—Al—O—F layer.

According to another embodiment, the all-solid-state battery has improved lifespan characteristics compared to an all-solid-state battery including a cathode active material that does not include a Li-M-O—F protection layer.

Another aspect of the present invention relates to a device including the all-solid-state battery according to various embodiments of the present invention. The device may be selected from an electric vehicle, a hybrid vehicle, an Energy Storage System (ESS), a portable electronic device, and combinations thereof.

Hereinafter, the present invention will be described in more detail through examples, etc., but the scope and content of the present invention cannot be interpreted as being reduced or limited by the examples, etc. below.

Also, based on the disclosure of the present invention including the following examples, it is obvious that a person skilled in the art can easily carry out the present invention for which experimental results are not specifically presented, and it is natural that such variations and modifications fall within the appended claims.

In addition, the experimental results presented below describe only representative experimental results of the above examples and comparative examples, and the respective effects of various embodiments of the present invention not explicitly presented below will be specifically described in the relevant sections.

### EXAMPLES

### Chemicals

Lithium tert-butoxide (LiOtBu, 97%, Sigma Aldrich), trimethylaluminum (TMA, 97%, Sigma Aldrich), XeF₂ powder, lithium ethoxide (95%, Sigma-Aldrich), aluminum isopropoxide (>98%, Sigma-Aldrich), Li₆PS₅Cl (LPSCl) powder, ZrO₂—2Li₂ZrCl₅F electrolyte, Li₃YCl₆ electrolyte, Li-rich Manganese-based cathode material (LMR, Li_{1.08}Ni_{0.37}Co_{0.02}Mn_{0.53}O₂), and vapor-grown carbon fiber powder (Sigma-Aldrich) were used. All chemicals were used without separate additional purification.

### Preparation Example 1: Formation of Li—Al—O Layer by Atomic Layer Deposition (ALD)

Lithium-aluminum oxide (LAO) was coated on LMR powder using ALD (Savannah S200, Veeco). Lithium tert-butoxide (LiOtBu) was put in a stainless steel cylinder and heated to 130° C. The pulse time of LiOtBu was set to 4.0 seconds, the exposure time to 0.5 seconds, and the purge time to 20 seconds. Trimethylaluminum (TMA) was put in a stainless steel cylinder and maintained at room temperature, and a pulse time of 0.25 seconds, an exposure time of 2.0 seconds, and a purge time of 20 seconds were used. In the purge step, Ultra High Purity Ar was used at a flow rate of 10 sccm for LiOtBu, TMA, and ozone, and 5 sccm was used in the precursor exposure step. Ozone was generated from ultra high purity O₂ using a UV ozone generator (Veeco). The substrate temperature was set to 200° C.

### Preparation Example 2: Formation of Li—Al—O Layer by Wet Chemical Method

Lithium ethoxide and aluminum isopropoxide were used without separate additional treatment. Li—Al—O was synthesized from a stoichiometric homogeneous aqueous solution (0.03 M) containing lithium ethoxide and aluminum isopropoxide. The solvent was evaporated under vacuum at 80° C. using a rotary evaporator, and then heat-treated at 450° C. for 1 hour in an air atmosphere.

### Preparation Example 3: Vapor Phase Fluorination Treatment

Li—Al—O coated LMR (or bare LMR) and XeF₂ powder were separated at a mass ratio of 10:1 and put into two polytetrafluoroethylene (PTFE) containers, respectively. Thereafter, these two PTFE containers were put together inside a larger PTFE reactor container. The reactor container was maintained at 60° C. for 6 hours.

### Example 1: Cathode Active Material with Li—Al—O—F Protection Laver Formed (for Sulfide-Based Electrolyte)

For the LMR powder on which the Li—Al—O layer was formed by ALD in Preparation Example 1, the vapor phase fluorination treatment of Preparation Example 3 was performed to prepare a cathode active material on which a Li—Al—O—F (LAOF) protection layer was formed. An all-solid-state battery was fabricated together with a sulfide-based solid electrolyte (Li₆PS₅Cl).

### Example 2: Cathode Active Material with Li—Al—O—F Protection Layer Formed (for Halide-Based Electrolyte—ZrO₂-LZCF)

For the LMR powder on which the Li—Al—O layer was formed by ALD in Preparation Example 1, the vapor phase fluorination treatment of Preparation Example 3 was performed to prepare a cathode active material on which a Li—Al—O—F protection layer was formed. An all-solid-state battery was fabricated together with a halide-based solid electrolyte (ZrO₂—2Li₂ZrCl₅F).

### Example 3: Cathode Active Material with Li—Al—O—F Protection Layer Formed (for Halide-Based Electrolyte—LYC)

For the LMR powder on which the Li—Al—O layer was formed by ALD in Preparation Example 1, the vapor phase fluorination treatment of Preparation Example 3 was performed to prepare a cathode active material on which a Li—Al—O—F protection layer was formed. An all-solid-state battery was fabricated together with a halide-based solid electrolyte (Li₃YCl₆).

### Example 4: Spinel Cathode Active Material with Li—Al—O—F Protection Layer Formed (for Halide-Based Electrolyte)

After forming a Li—Al—O layer on LiNi_{0.5}Mn_{1.5}O₄ (LNMO) powder under the same ALD conditions as in Preparation Example 1, the vapor phase fluorination treatment of Preparation Example 3 was performed to prepare a cathode active material on which a Li—Al—O—F protection layer was formed. An all-solid-state battery was fabricated together with a halide-based solid electrolyte (ZrO₂—2Li₂ZrCl₅F).

### Comparative Example 1: Uncoated Cathode Active Material (for Sulfide-Based Electrolyte)

LMR powder was used as a cathode active material as it is without separate coating treatment. An all-solid-state battery was fabricated together with a sulfide-based solid electrolyte (Li₆PS₅Cl).

### Comparative Example 2: Uncoated Cathode Active Material (for Halide-Based Electrolyte—ZrO₂-LZCF)

LMR powder was used as a cathode active material as it is without separate coating treatment. An all-solid-state battery was fabricated together with a halide-based solid electrolyte (ZrO₂—2Li₂ZrCl₅F).

### Comparative Example 3: Uncoated Cathode Active Material (for Halide-Based Electrolyte—LYC)

LMR powder was used as a cathode active material as it is without separate coating treatment. An all-solid-state battery was fabricated together with a halide-based solid electrolyte (Li₃YCl₆).

### Comparative Example 4: XeF₂ Alone Treated Cathode Active Material

Without forming a Li—Al—O layer, only the vapor phase fluorination treatment (XeF₂) of Preparation Example 3 was performed alone on LMR powder to prepare a cathode active material. An all-solid-state battery was fabricated together with a halide-based solid electrolyte (ZrO₂-2Li₂ZrCl₅F).

### Comparative Example 5: Wet Method Li—Al—O—F Cathode Active Material

After forming a Li—Al—O layer by the wet chemical method of Preparation Example 2, the vapor phase fluorination treatment of Preparation Example 3 was performed to prepare a cathode active material on which a Li—Al—O—F protection layer was formed. An all-solid-state battery was fabricated together with a halide-based solid electrolyte (ZrO₂—2Li₂ZrCl₅F).

### Comparative Example 6: Uncoated Spinel Cathode Active Material (for Halide-Based Electrolyte)

LiNi_{0.5}Mn_{1.5}O₄ (LNMO) powder was used as a cathode active material as it is without separate coating treatment. An all-solid-state battery was fabricated together with a halide-based solid electrolyte (ZrO₂—2Li₂ZrCl₅F).

TABLE 1

| Category | Cathode Active Material | Coating Layer | Electrolyte |
|---|---|---|---|
| Example 1 | Li_{1.08}Ni_{0.37}Co_{0.02}Mn_{0.53}O₂ | Li—Al—O—F (ALD) | Li₆PS₅Cl (Sulfide-based) |
| Example 2 | Li_{1.08}Ni_{0.37}Co_{0.02}Mn_{0.53}O₂ | Li—Al—O—F (ALD) | ZrO₂—2Li₂ZrCl₅F |
| Example 3 | Li_{1.08}Ni_{0.37}Co_{0.02}Mn_{0.53}O₂ | Li—Al—O—F (ALD) | Li₃YCl₆ |
| Example 4 | LiNi_{0.5}Mn_{1.5}O₄ | Li—Al—O—F (ALD) | ZrO₂—2Li₂ZrCl₅F |
| Example 5 | LiNi_{0.9}Co_{0.06}Mn_{0.04}O₂ | Li—Al—O—F (ALD) | Li₆PS₅Cl (Sulfide-based) |
| Comp. Ex. 1 | Li_{1.08}Ni_{0.37}Co_{0.02}Mn_{0.53}O₂ | None | Li₆PS₅Cl (Sulfide-based) |
| Comp. Ex. 2 | Li_{1.08}Ni_{0.37}Co_{0.02}Mn_{0.53}O₂ | None | ZrO₂—2Li₂ZrCl₅F |
| Comp. Ex. 3 | Li_{1.08}Ni_{0.37}Co_{0.02}Mn_{0.53}O₂ | None | Li₃YCl₆ |
| Comp. Ex. 4 | Li_{1.08}Ni_{0.37}Co_{0.02}Mn_{0.53}O₂ | F | ZrO₂—2Li₂ZrCl₅F |
| Comp. Ex. 5 | Li_{1.08}Ni_{0.37}Co_{0.02}Mn_{0.53}O₂ | Li—Al—O—F (Wet) | ZrO₂—2Li₂ZrCl₅F |
| Comp. Ex. 6 | LiNi_{0.5}Mn_{1.5}O₄ | None | ZrO₂—2Li₂ZrCl₅F |
| Comp. Ex. 7 | LiNi_{0.9}Co_{0.06}Mn_{0.04}O₂ | None | Li₆PS₅Cl (Sulfide-based) |

### Example 5: Cell Fabrication

A cell with a diameter of 13 mm was assembled, a Ti rod was used as a current collector, and a poly(aryl-ether-ether-ketone) mold wrapped with stainless steel was used. For LPSCl monolayer formation, LPSCl powder (150 mg, about 600 μm) was pelletized at about 70 MPa with a hydraulic press (3850 mini-c, Carver), which corresponds to a force of 1 metric ton. The composite cathode was prepared by mixing cathode active material (CAM), solid electrolyte (SE), and vapor-grown carbon fiber powder in a weight ratio of 70:50:5 using a mortar and pestle. Finally, the cathode and the anode were placed on both sides of the solid electrolyte layer and then pressurized at about 380 MPa. The all-solid-state cell was tested under conditions of about 70 MPa and 3 MPa. All all-solid-state battery half-cells were driven in the range of 2.3-4.8 V (vs Li/Li+) at 60° C. However, in the case of Example 4 and Comparative Example 6 using the spinel cathode material (LiNi_{0.5}Mn_{1.5}O₄), they were driven in the range of 3.0-5.0 V (vs Li/Li⁺) at 60° C.

### Test Example 1: X-Ray Photoelectron Spectroscopy (XPS) Analysis

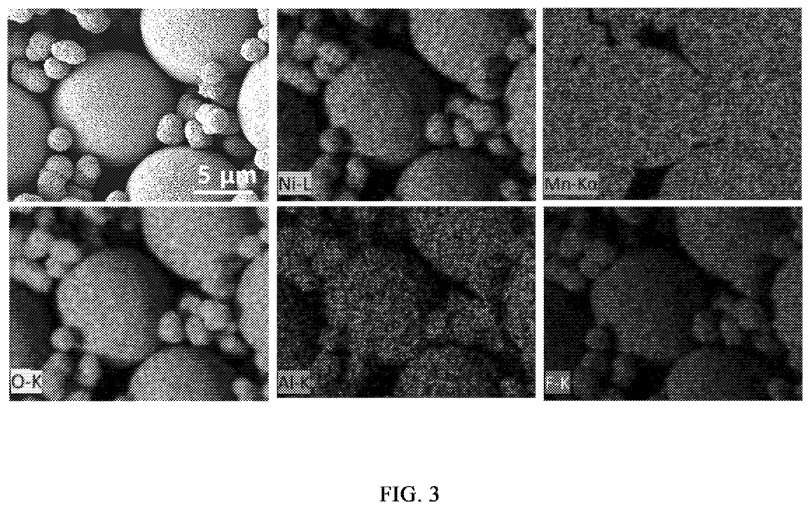

After applying both ALD and XeF₂ processes, XPS analysis was performed to investigate the chemical bonding and composition of the coating layer (FIG. 2). As a result of comparing the spectra before and after the fluorination treatment, it was confirmed that the F-related signal clearly increased together with the Al—O based bonding signal. This supports that the LAO precursor layer formed by ALD was partially fluorinated by XeF₂ and converted into an oxyfluoride composition (LAOF).

As a result of XPS quantification, the element ratio of the coating layer was confirmed to be Li 22.51%, Al 22.46%, O 36.88%, and F 18.15%, and based on this, the average chemical composition of the formed interface protection layer is determined to be LiAlO_{1.6}F_{0.8} (Lithium aluminum oxyfluoride).

### Test Example 2: Scanning Electron Microscope (SEM) and EDS Analysis

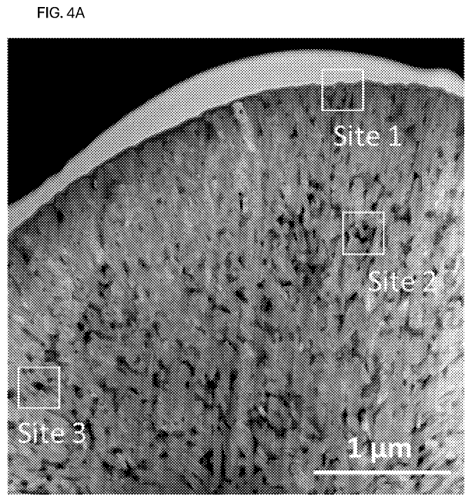

The microstructure of LMR into which the Li—Al—O—F interface protection layer formed through ALD and XeF₂ processes was introduced was confirmed by SEM, and the results are presented in FIG. 3. Through SEM-EDS analysis, it was confirmed that the coating elements (Al, F) were uniformly distributed on the surface of the cathode active material.

### Test Example 3: Transmission Electron Microscope (TEM) and EDS Analysis

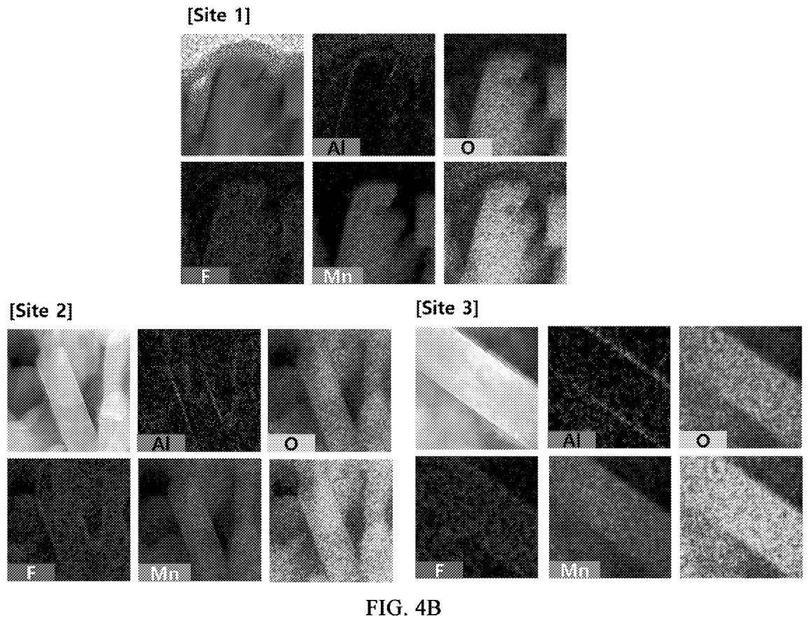

The morphology and crystal structure were analyzed using TEM, and the results are presented in FIG. 4A and FIG. 4B. When XeF₂ vapor phase fluorination treatment is applied to the Li—Al—O layer formed by ALD, it can be confirmed that a conformal coating layer of nanometer thickness is formed on the surface.

In particular, in TEM observation, the coating layer was observed not only on the particle surface but also in the grain boundary region inside the composite cathode, suggesting the possibility of diffusion/infiltration type coating provided by the vapor phase reaction-based process. As can be confirmed at Sites 2 and 3 in FIG. 4A, it can be confirmed that the interface protection layer is well introduced not only on the surface but also at a depth of about 1 μm from the surface.

In the line EDS element mapping result of FIG. 4B, it can be confirmed that a uniform interface protection layer of about 4 nm thickness was introduced.

### Test Example 4: Electrochemical Evaluation (Rate Capability)

To verify the performance effect of the formed oxyfluoride interface layer, electrochemical evaluation was performed by applying various solid electrolytes under different stack pressure (3 MPa and 70 MPa) conditions.

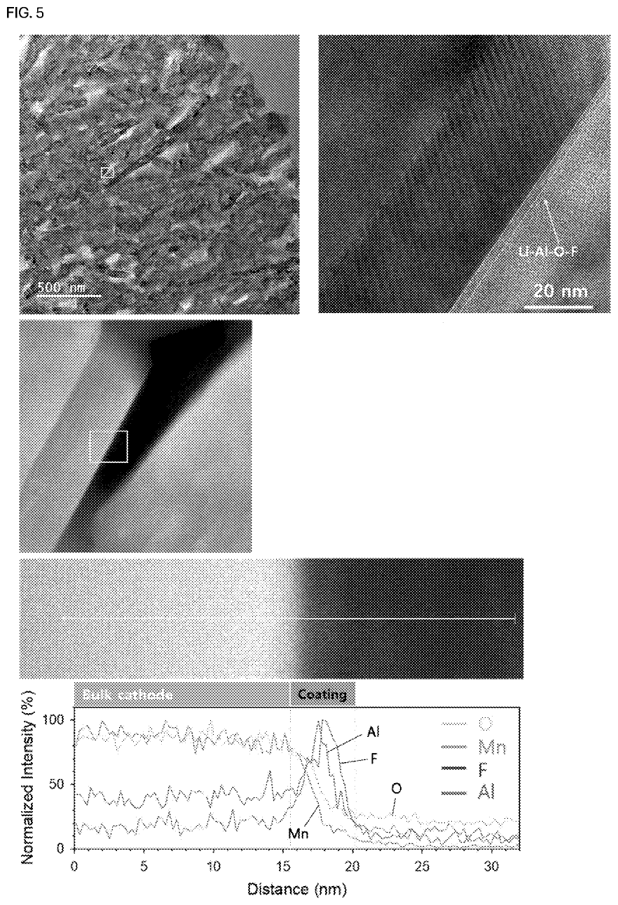

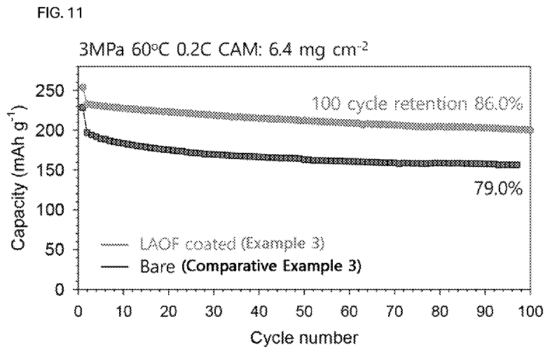

### (1) Case of Using Sulfide-Based Solid Electrolyte (FIG. 5, FIG. 11)

Example 1 (Li—Al—O—F coating) and Comparative Example 1 (uncoated) were compared at a high driving pressure of 70 MPa. In the case of using a sulfide-based solid electrolyte (LPSCl), the reversible capacity was improved compared to the uncoated cathode, which is interpreted as being due to the interface protection effect of the Li—Al—O—F layer. The initial coulombic efficiency (ICE) of Example 1 was 91.1%, which was remarkably improved compared to 84.6% of Comparative Example 1, and excellent performance could also be confirmed in rate capability.

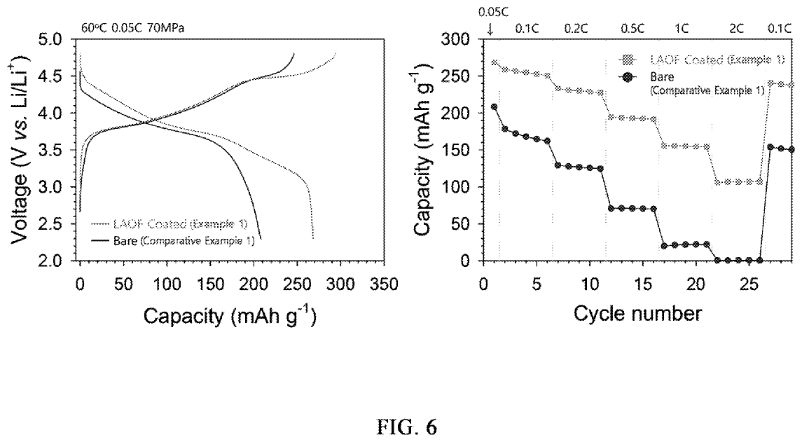

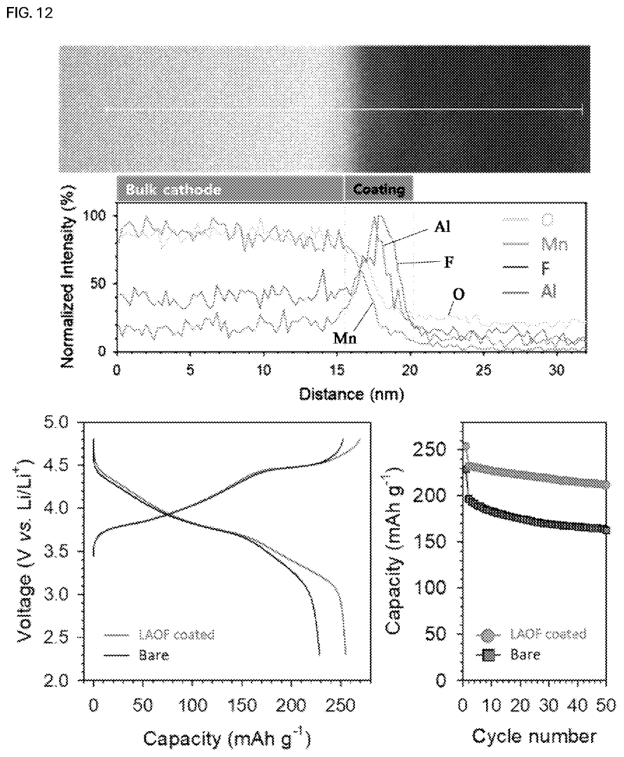

### (2) Case of Using Halide-Based Solid Electrolyte (FIG. 6, FIG. 12)

Example 2, Comparative Example 2, and Comparative Example 4 were compared and evaluated using ZrO₂-2Li₂ZrCl₅F electrolyte known to have relatively excellent electrochemical stability. Example 2 (ALD+XeF₂) showed an initial coulombic efficiency (ICE) of 96.3%, which was excellent performance compared to 91.5% of Comparative Example 2. On the other hand, in the case of Comparative Example 4 (XeF₂ treated alone), it was difficult to sufficiently form a Li+conductive protection layer on the cathode surface, and polarization rather increased, resulting in a decrease in capacity. That is, it was confirmed that it is difficult to secure excellent electrochemical performance only with XeF₂ treatment alone.

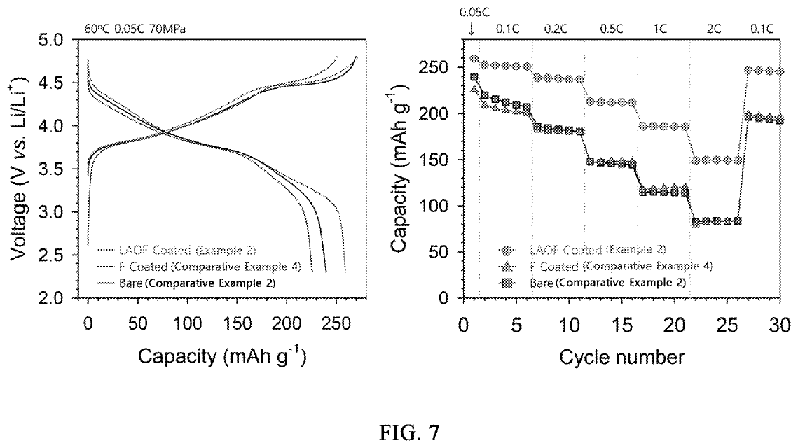

### (3) Wet Method Comparative Evaluation (FIG. 7)

Comparative Example 5, in which a Li—Al—O based protection layer was introduced by a solution method instead of ALD and then the same XeF₂ fluorination strategy was applied, and uncoated Comparative Example 2 were compared. As a result, interface stability was improved and capacity increased compared to the uncoated sample (Comparative Example 2), but it still showed lower performance than Example 2 in which XeF₂ treatment was applied after ALD. This suggests that the ALD process should be preceded for uniform and dense precursor layer formation.

### Test Example 5: Electrochemical Evaluation (Lifespan Characteristics)

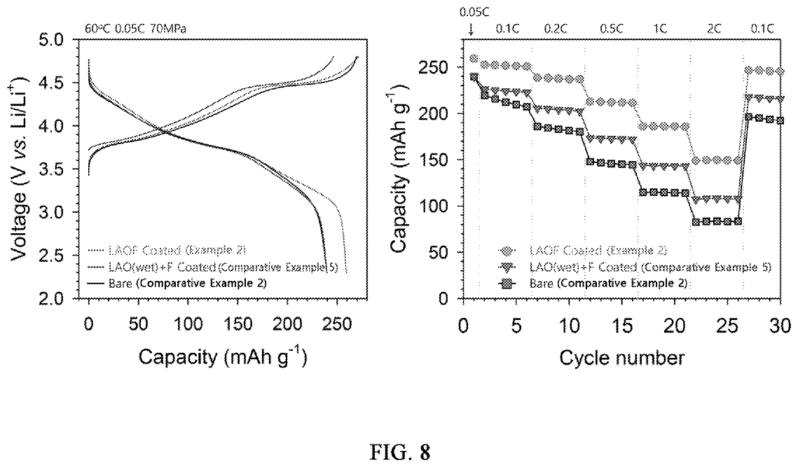

This electrochemical improvement effect was confirmed not only in rate capability but also in lifespan characteristics (FIG. 8). As a result of comparing lifespan characteristics by cycling Example 2 and Comparative Example 2 for a long period at a high driving pressure of 70 MPa, Example 2 showed a capacity retention rate of 85.1% after 200 cycles, whereas Comparative Example 2 remained at 72.4%, showing that the Example exhibited remarkably excellent lifespan characteristics.

### Test Example 6: Electrochemical Evaluation Under Low Pressure Driving Conditions

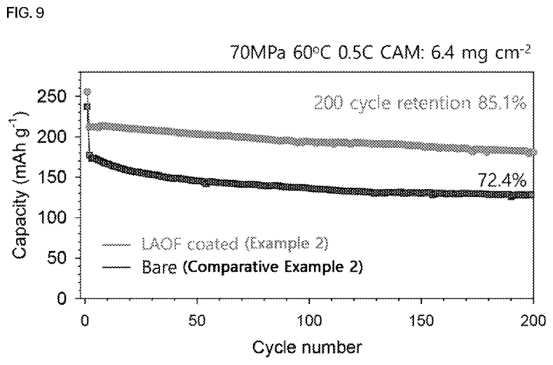

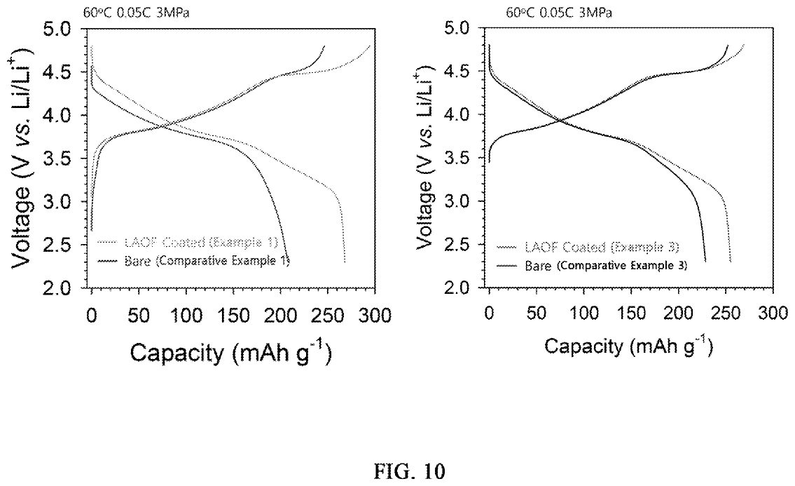

Electrochemical evaluation was also performed under low pressure driving conditions (3 MPa), which is important from the perspective of commercialization of all-solid-state batteries (FIG. 9, FIG. 10).

### (1) Rate Capability (FIG. 9)

Example 1 and Comparative Example 1 (left) using a sulfide-based electrolyte (LPSCl) at a low driving pressure of 3 MPa, and Example 3 and Comparative Example 3 (right) using a halide-based electrolyte (Li₃YCl₆) were compared. In both cases, the cathode active material with the Li—Al—O—F protection layer formed (Example) showed excellent rate capability compared to the uncoated cathode active material (Comparative Example). This proves that the interface protection strategy according to the present invention is effective even in a low pressure environment.

### (2) Lifespan Characteristics (FIG. 10)

As a result of comparing lifespan characteristics of Example 3 and Comparative Example 3 using Li₃YCl₆ halide-based electrolyte at a low driving pressure of 3 MPa, Example 3 showed a capacity retention rate of 86.0% after 100 cycles, whereas Comparative Example 3 remained at 79.0%, showing that the same performance improvement was reproduced.

In conclusion, it was confirmed that the method of the present invention, in which a Li—Al—O thin film is formed by ALD and then converted into Li—Al—O—F by XeF₂ low-temperature vapor phase fluorination, uniformly coats not only the surface of the cathode active material but also the grain boundaries inside the active material, thereby suppressing high voltage interface reactions and implementing a stable interface, improving both rate capability and lifespan characteristics of the all-solid-state battery.

### Test Example 7: Electrochemical Evaluation for Spinel Cathode Material (LNMO)

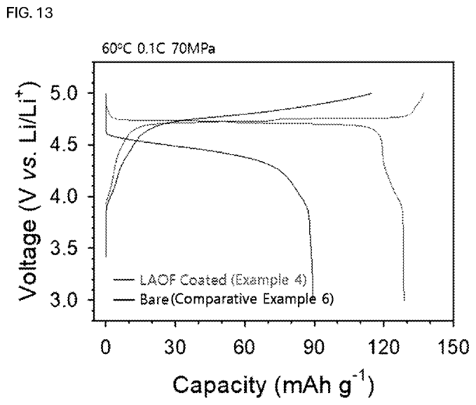

To confirm whether the Li—Al—O—F protection layer according to the present invention is also effective for a high voltage cathode material of a spinel structure, electrochemical evaluation was performed using LiNi_{0.5}Mn_{1.5}O₄ (LNMO) as a cathode active material (FIG. 13). As a result of comparing Example 4 (Li—Al—O—F coating) and Comparative Example 6 (uncoated) under conditions of 70 MPa, 60° C., and 0.1C, Example 4 into which the Li—Al—O—F protection layer was introduced showed improved discharge capacity compared to Comparative Example 6. This confirmed that the interface protection effect of the Li-M-O—F protection layer according to the present invention is effective not only for Li-rich cathode materials but also for spinel cathode materials driven at high voltages of 4.7 V or higher.

### Test Example 8: Electrochemical Evaluation for Layered Cathode Material (Ni-Rich NCM)

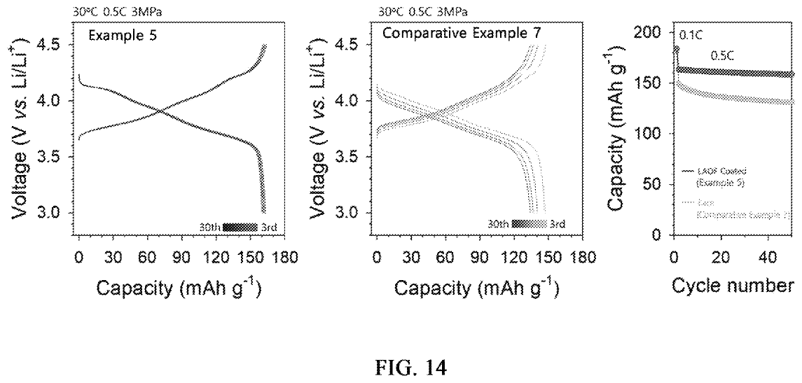

To confirm whether the Li—Al—O—F protection layer according to the present invention is also effective for high voltage driving of a 4V class layered cathode material, electrochemical evaluation was performed using LiNi_{0.9}Co_{0.06}Mn_{0.04}O₂ (Ni-rich NCM) as a cathode active material (FIG. 14). As a result of comparing Example 5 (Li—Al—O—F coating) and Comparative Example 7 (uncoated) under conditions of 3 MPa, 30° C., 1 cycle of 0.1C, and then 0.5C, Example 5 into which the Li—Al—O—F protection layer was introduced showed improved discharge capacity compared to Comparative Example 7, and after 50 cycles, Example 5 showed a capacity retention rate of 97.1%, whereas Comparative Example 7 remained at 87.9%. This confirmed that the interface protection effect of the Li-M-O—F protection layer according to the present invention is effective even for driving at a high voltage of 4.5 V or higher of the Ni-rich cathode material.

What is claimed is:

1. A cathode active material for a lithium secondary battery comprising:
(A) a cathode active material core including a lithium transition metal oxide, and
(B) a lithium-metal-oxygen-fluorine (Li-M-O—F) protection layer formed on at least a part of the surface of said cathode active material core.

2. The cathode active material of claim 1, wherein the lithium transition metal oxide is selected from a nickel-rich (Ni-rich) cathode material or a lithium-rich (Li-rich) cathode material.

3. The cathode active material for a lithium secondary battery of claim 1, wherein the lithium transition metal oxide is represented by the following Formula 1a: 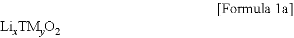
In Formula 1a, x is a real number of 0.5-1.5, y is a real number of 0.5-1.5, and TM is selected from Ni, Co, Mn, Al, Fe, Cr, V, Ti, Nb, Zr, W, Mo, Mg, Ca, Na, B, Si, P, and combinations thereof.

4. The cathode active material for a lithium secondary battery of claim 1, wherein the lithium transition metal oxide is represented by the following Formula 1b: 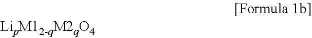
In Formula 1b, p is a real number of 0-2, q is a real number of 0-2, and M1 and M2 are each independently selected from Ni, Co, Mn, Al, Fe, Cr, V, Ti, Nb, Zr, W, Mo, Mg, Ca, Na, and combinations thereof.

5. The cathode active material for a lithium secondary battery of claim 1, wherein the lithium transition metal oxide is a cathode material of a spinel structure.

6. The cathode active material for a lithium secondary battery of claim 1, wherein the lithium transition metal oxide is selected from LiNi_{0.5}Mn_{1.5}O₄, LiCoMnO₄, and combinations thereof.

7. The cathode active material for a lithium secondary battery of claim 1, wherein the protection layer is represented by the following Formula 2: 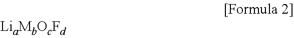
In Formula 2, a is a real number of 0-4, b is a real number greater than 0 and 1 or less, c is a real number of 0-4, d is a real number greater than 0 and 4 or less, and M is selected from Al, B, C, Nb, Ta, P, Si, and combinations thereof.

8. The cathode active material of claim 7, wherein the M is Al, and the protection layer has a Li—Al—O—F composition.

9. The cathode active material of claim 8, wherein the average chemical composition of the Li—Al—O—F protection layer is LiAlO_{1.6}F_{0.8}.

10. The cathode active material of claim 1, wherein the thickness of the lithium-metal-oxygen-fluorine (Li-M-O—F) protection layer is 1-20 nm.

11. The cathode active material of claim 1, wherein the thickness of the lithium-metal-oxygen-fluorine (Li-M-O—F) protection layer is 2-10 nm.

12. The cathode active material of claim 1, wherein the lithium-metal-oxygen-fluorine (Li-M-O—F) protection layer is formed not only on the surface of the cathode active material core but also at the grain boundaries inside the cathode active material core.

13. The cathode active material of claim 12, wherein the lithium-metal-oxygen-fluorine (Li-M-O—F) protection layer is a vapor phase fluorination product of a lithium-metal-oxygen (Li-M-O) precursor layer, and is formed at the grain boundaries up to a depth of 1 μm from the surface of the cathode active material core.

14. The cathode active material of claim 13, wherein the lithium-metal-oxygen (Li—M-O) precursor layer is formed by Atomic Layer Deposition (ALD), and the vapor phase fluorination is performed using a fluorine source selected from XeF₂, NH₄F, SF₆, CF₄, TiF₄, TaF₅, and combinations thereof.

15. A cathode comprising the cathode active material according to claim 1.

16. An all-solid-state battery comprising:
the cathode according to claim 15; and
a solid electrolyte, wherein the solid electrolyte is a sulfide-based or halide-based solid electrolyte.

17. A device comprising the all-solid-state battery according to claim 16, wherein the device is selected from an electric vehicle, a hybrid vehicle, an Energy Storage System (ESS), and a portable electronic device.
